(19) United States
(12) Patent Application Publication
(10) Pub. No.: US 2022/0045778 A1
(43) Pub. Date: Feb. 10, 2022

(54) COMMUNICATION SYSTEM

(71) Applicant: Mitsubishi Electric Corporation, Tokyo (JP)

(72) Inventors: Yuki Fujita, Tokyo (JP); Daisuke Osagawa, Tokyo (JP)

(73) Assignee: Mitsubishi Electric Corporation, Tokyo (JP)

(21) Appl. No.: 17/506,757

(22) Filed: Oct. 21, 2021

Related U.S. Application Data
(63) Continuation of application No. PCT/JP2019/024403, filed on Jun. 20, 2019.

(51) Int. Cl. H04J 3/06

(52) U.S. Cl. CPC H04J 3/0679; H04J 3/0641

(57) ABSTRACT

A communication system (100) includes communication device (1) to communication device (9). Communication device (1) to communication device (9) select a first representative device that represents a same domain. Communication device (3) is selected from domain D (1), communication device (6) is selected from domain D (2), and communication device (9) is selected from domain D (3). For communication device (3), communication device (6), and communication device (9) selected from each domain, communication device (3) sets to communication device (3), communication device (6) sets to communication device (6), and communication device (9) sets to communication device (9), domain D (0) as a common domain to which communication device (3), communication device (6), and communication device (9) belong. Communication device (3), communication device (6), and communication device (9) select communication device (9) as a network grandmaster that is a second representative device that represents domain D (0).

### CROSS REFERENCE TO RELATED APPLICATIONS

This application is a Continuation of PCT International Application No. PCT/JP2019/024403, filed on Jun. 20, 2019, which is hereby expressly incorporated by reference into the present application.

### Technical Field

The present invention relates to time synchronization of a communication system that includes a plurality of communication devices.

### Background Art

As a representative of a time synchronization protocol to realize highly accurate time synchronization, there is a time synchronization protocol based on IEEE802.1AS. In IEEE802.1AS, a grandmaster that is to be a standard of time is selected out of a group of communication devices based on a Best Master Clock Algorithm (BMCA). In the BMCA, a communication device delivers to all other communication devices, priority information that the communication device has for selecting a grandmaster. The communication device compares priority information received from a different communication device with the priority information that the communication device has, and selects a device with a higher priority as the grandmaster. The communication device that is selected as the grandmaster delivers time information that the communication device has to a slave. The slave is a communication device that synchronizes with the grandmaster. The slave synchronizes with time that the time information delivered from the grandmaster indicates. Thus, time synchronization for all of the communication devices in a network is realized. In a production site, for realizing motion control that is high speed and highly accurate, real-time collection of data generated in a plurality of plants, and for realizing a real-time analyzation of the data generated in the plurality of plants, highly accurate time synchronization between the communication devices is in demand. Because of the above, an application of IEEE802.1AS is desirable.

In a specification of IEEE802.1AS, the number of relay stages for relay data transmitted from a grandmaster in a same domain is limited to as much as 256 stages. When the number of relay stages exceeds 256 stages, the communication device will become excluded from the time synchronization. Because of the above, the time synchronization in a network having a domain with the number of relay stages for relay data transmitted from the grandmaster exceeding 256 stages will not be guaranteed.

In Patent Literature 1, a method in which, among a plurality of slaves in a network, only a representative slave, a specific slave, directly synchronizes time with a grandmaster, and a different slave in a group to which the representative slave belongs synchronizing time with the representative slave, is proposed.

### CITATION LIST

### Patent Literature

Patent Literature 1: JP 2015-068806 A

### SUMMARY OF INVENTION

### Technical Problem

In Patent Literature 1, however, a time synchronization system in a network exceeding the maximum number of connections is not either disclosed or suggested. That is, a case where the number of relay stages of the relay data transmitted from the grandmaster exceeds the maximum number of relay stages in a same domain, is not either disclosed or suggested.

The present invention aims to provide a communication system in which time synchronization is possible even in a case where the number of relay stages of relay data transmitted from a grandmaster exceeds the maximum number of relay stages in a same domain.

### Solution to Problem

A communication system of the present invention includes:

a plurality of communication devices.

Each communication device of the plurality of communication devices includes a selection unit, and a domain management unit having a domain setting that indicates a domain among a plurality of domains to which the communication device belongs,

in a plurality of the communication devices that belong to the domain that is a same, the selection unit of each selects a first representative device that is a communication device that represents the domain that is the same, and

in a plurality of the first representative devices selected from each of the domains, the domain management unit of each sets a common domain to which the plurality of the first representative devices belong, and the selection unit of each selects a second representative device that represents the common domain from the plurality of the first representative devices.

### Advantageous Effects of Invention

According to a communication system of the present invention, a communication system that is capable of time synchronization even in a case where the number of relay stages of relay data transmitted from a grandmaster exceeds the maximum number of relay stages in a same domain can be provided.

### BRIEF DESCRIPTION OF DRAWINGS

FIG. 1 is a diagram illustrating Embodiment 1, and a diagram schematically illustrating a communication system 100.

FIG. 2 is a diagram illustrating Embodiment 1, and a diagram illustrating a hardware configuration of a communication device 1.

FIG. 3 is a diagram illustrating Embodiment 1, and a flowchart illustrating operation of the communication system 100.

FIG. 4 is a diagram illustrating Embodiment 1, and a diagram schematically illustrating the operation of the communication system 100.

FIG. 5 is a diagram illustrating Embodiment 2, and a diagram illustrating a hardware configuration of a communication device 1.

FIG. 6 is a diagram illustrating Embodiment 2, and a diagram illustrating domain types.

FIG. 7 is a diagram illustrating Embodiment 2, and a flowchart illustrating operation of a communication system 100.

FIG. 8 is a diagram illustrating Embodiment 2, and a diagram schematically illustrating the operation of the communication system 100.

FIG. 9 is a diagram illustrating Embodiment 2, and a diagram illustrating domain reorganization information 90.

FIG. 10 is a diagram illustrating Embodiment 2, and a diagram illustrating reorganization of domains.

FIG. 11 is a diagram illustrating Embodiment 2, and a diagram illustrating changes in the domain reorganization information 90.

### DESCRIPTION OF EMBODIMENTS

The embodiments of the present invention will be described hereinafter using the drawings. Throughout the drawings, the same or corresponding portions are denoted by the same reference signs. In the description of the embodiments, a description of the same or corresponding portions will be suitably omitted or simplified.

In Embodiment 1 and Embodiment 2 to be described hereinafter, there is a limit to the maximum number of connections in a network, and in a time synchronization protocol where a time delivery is performed by a grandmaster that is selected, time synchronization in a network exceeding the maximum connection stations is realized.

The maximum number of connections in a network is the maximum number of relay stages in a same domain. In Embodiment 1 and Embodiment 2, to deal with the number of relay stages of the relay data, the relay data being made to be relayed from a grandmaster to a slave, exceeding the maximum number of relay stages in the same domain, the same domain is divided into a plurality of domains. Hereinafter, a description will be given in detail.

Embodiment 1.

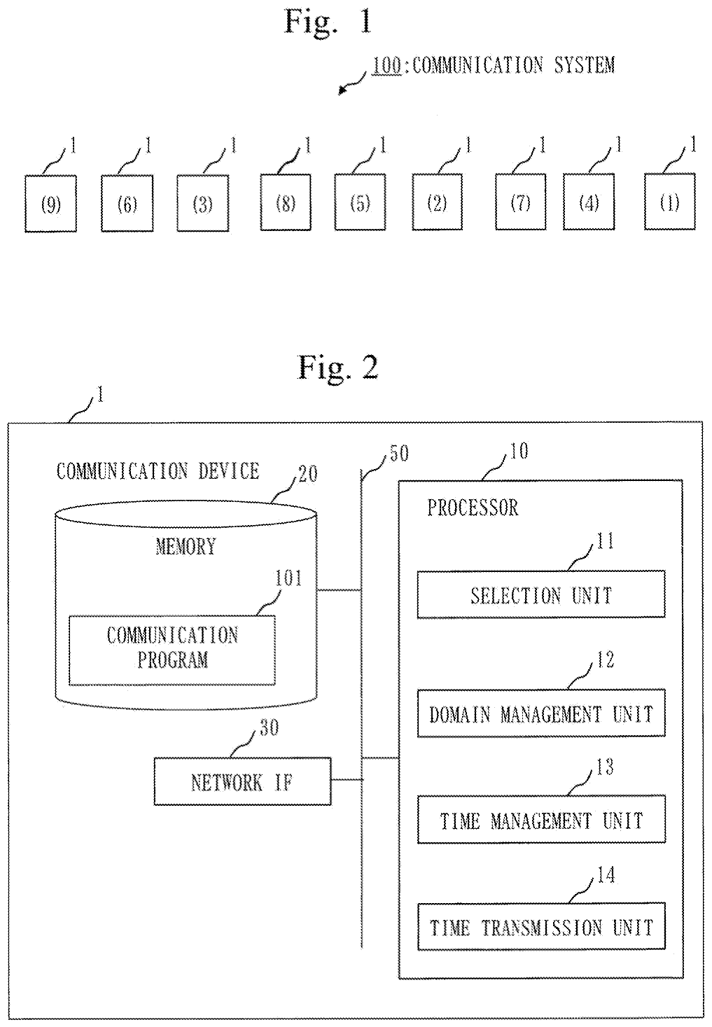

Embodiment 1 will be described by referring to FIG. 1 to FIG. 4. Hereinafter, communication devices 1 will be differentiated by being written as communication device (1) and communication device (2). The domains will be differentiated by being written as domain D (0) and domain D (1).

Domain D (0) is domain number=0, and domain D (1) is domain number=1.

FIG. 1 schematically illustrates a communication system 100. The communication system 100 includes a plurality of communication devices 1. In FIG. 1, a situation where the plurality of communication devices 1 being connected in a line is illustrated. In FIG. 1, nine communication devices 1 from communication device (1) to communication device (9) are connected in a line. A connection being in a line is an example given for description, and a network configuration is not limited to the connection being in a line.

*** Description of Configuration ***

FIG. 2 illustrates a hardware configuration of the communication device 1. The hardware configuration of the communication device 1 will be described by referring to FIG. 2.

The communication device 1 is a computer. The communication device 1 includes a processor 10. Other than the processor 10, the communication device 1 includes hardware such as a memory 20, a network interface 30, and the like. Hereinafter, interface will be written as IF. The processor 10 is connected to other hardware via a signal line 50, and controls other hardware.

The communication device 1 includes, as functional elements, a selection unit 11, a domain management unit 12, a time management unit 13, and a time transmission unit 14. Functions of the selection unit 11, the domain management unit 12, the time management unit 13, and the time transmission unit 14 are realized by a communication program 101.

The processor 10 is a device that executes the communication program 101. The communication program 101 is a program that realizes the functions of the selection unit 11, the domain management unit 12, the time management unit 13, and the time transmission unit 14. The communication program 101 is stored in the memory 20. The processor 10 is an IC (Integrated Circuit) that performs a calculation process. Specific examples of the processor 10 are a CPU (Central Processing Unit), a DSP (Digital Signal Processor), and a GPU (Graphics Processing Unit).

The memory 20 is a storage device. The memory 20 includes a volatile memory and a non-volatile memory. Specific examples of the memory 20 are an SRAM (Static Random Access Memory) and a DRAM (Dynamic Random Access Memory).

Or, a specific example of the memory 20 is an HDD (Hard Disk Drive). The memory 20 may be a portable recording medium such as an SD (registered trademark) (Secure Digital) memory card, a NAND flash, a flexible disc, an optical disc, a compact disc, a Blu-ray (registered trademark) disc, or a DVD (Digital Versatile Disk).

The network IF 30 is a physical port for the processor 10 to communicate with a different communication device 1.

The processor 10 reads the communication program 101 from the memory 20 and executes the communication program 101. The communication device 1 may include a plurality of processors that replace the processor 10. These plurality of processors share execution of the communication program 101. Each processor, as with the processor 10, is a device that executes the communication program 101. The processor 10 and the plurality of processors are called processing circuitry. The functions of the selection unit 11, the domain management unit 12, the time management unit 13, and the time transmission unit 14 may be realized by the processing circuitry. Or, functions of the processor 10, the memory 20, and the network IF 30 of the communication device 1 may be realized by the processing circuitry.

Data, information, signal values, and variable values used, processed, or outputted by the communication program 101 are stored in the memory 20, or a register or a cache memory in the processor 10.

The communication program 101 is a program that makes a computer execute each process, each procedure or each step being “process”, “procedure”, or “step” with which “unit” of the selection unit 11, the domain management unit 12, the time management unit 13, and the time transmission unit 14 are replaced.

A communication method is a method that is performed by the communication device 1, a computer, executing the communication program 101. The communication program 101 may be provided being stored in a computer-readable recording medium or may be provided as a program product.

(1) The selection unit 11 performs a selection process of a grandmaster between a different communication device 1.

(2) The domain management unit 12 has a domain setting that indicates, among a plurality of domains, a domain to which the communication device 1 of the domain management unit 12 belongs. A domain management unit manages a domain setting to which the communication device 1 itself belongs. The domain setting is a domain number.

(3) The time management unit 13 manages time information in the communication device 1.

(4) In a case where the communication device 1 is selected as the grandmaster, the time transmission unit 14 transmits to a different communication device 1, the time information that is held in the time management unit 13 via the network IF 30.

In Embodiment 1, a plurality of domains are set. The communication device 1 in a network belongs to one or more of the domains. Specifically, according to a protocol, each communication device 1 belongs to one or more of the domains of the plurality of domains. The domain management unit 12 manages the domain to which the communication device 1 belongs. Assume that the number of communication devices 1 that belong to each domain is less than or equal to the maximum number of connections specified in the protocol. That is, the number of communication devices 1 that belong to each domain is less than or equal to the maximum number of relay stages in a same domain specified in the protocol. A way to assign a domain to the communication device 1 can be freely selected. A specific domain, however, is to be a reserved domain, and the reserved domain will not have the communication device 1 belong to the reserved domain. The reserved domain is domain D (0), to be described later, for selecting the grandmaster.

*** Description of Operation ***

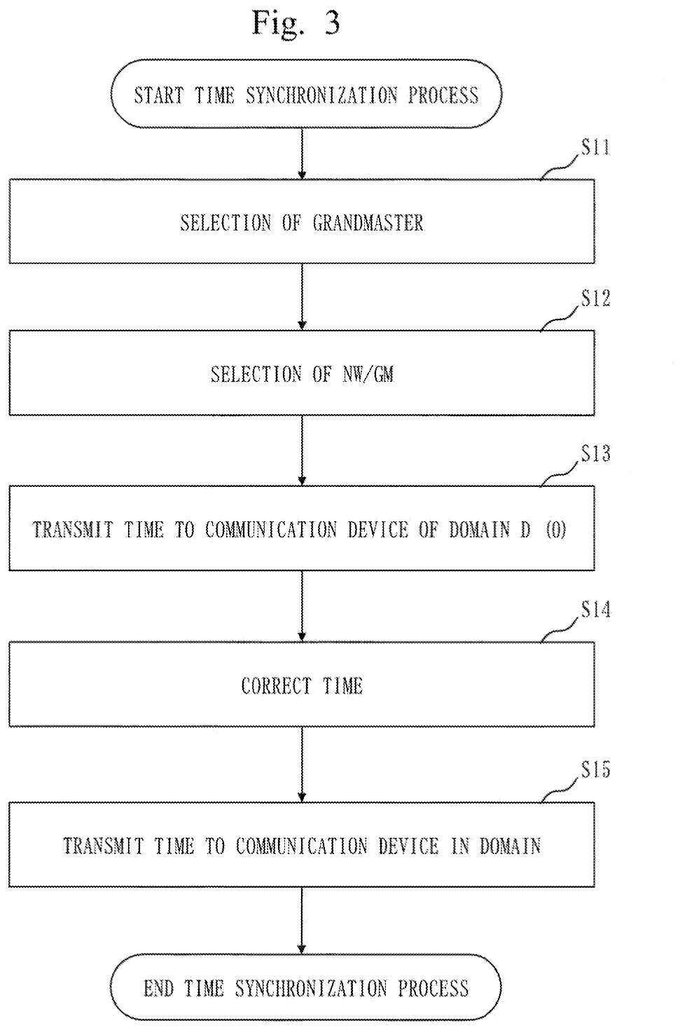

FIG. 3 is a flowchart illustrating operation of the communication system 100.

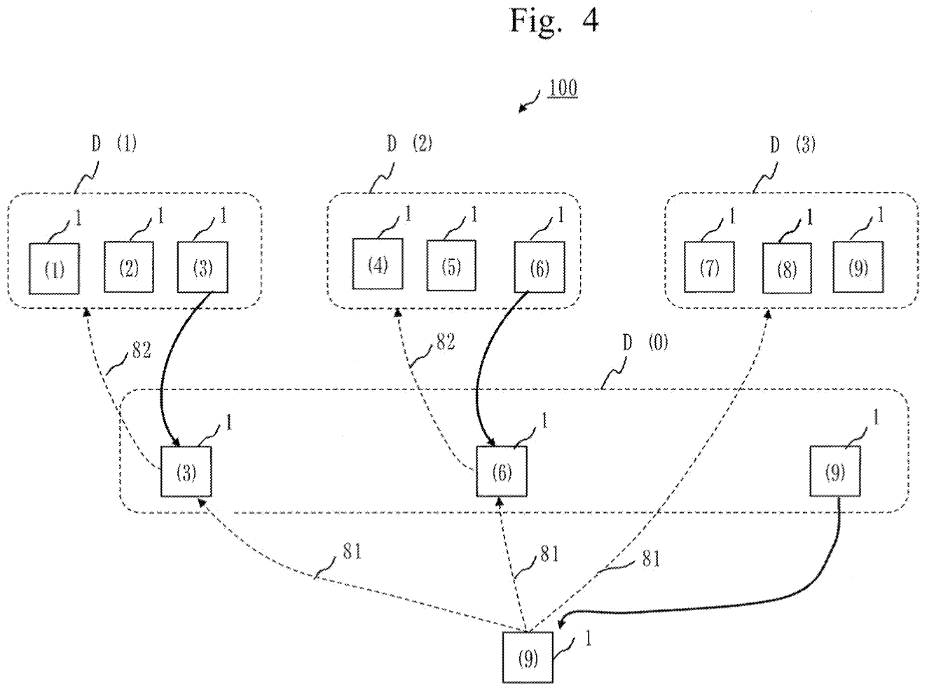

FIG. 4 schematically illustrates the operation of the communication system 100. Time synchronization of the communication system 100 will be described by referring to FIG. 3 and FIG. 4. An operation procedure of the communication device 1 corresponds to the communication method. A program that realizes operation of the communication device 1 corresponds to the communication program 101.

Hereinafter, a description will be given by referring to FIG. 4. In FIG. 4, the communication system 100 includes communication device (1) to communication device (9). Communication device (1), communication device (2), and communication device (3) belong to domain D (1). Communication device (4), communication device (5), and communication device (6) belong to domain D (2). Communication device (7), communication device (8), and communication device (9) belong to domain D (3).

<Step S11>

In step S11, a grandmaster is selected from each domain. In step S11, in a plurality of communication devices 1 that belong to a same domain, the selection unit 11 of each selects a first representative device, a communication device 1 that represents the same domain. The grandmaster is the first representative device. In a state of step S11, as illustrated in FIG. 4, communication device (1) to communication device (3) belong to domain D (1), communication device (4) to communication device (6) belong to domain D (2), and communication device (7) to communication device (9) are belonging to domain D (3). Each selection unit 11 of the communication devices 1 selects a grandmaster in each domain to which the communication devices 1 belong according to a system below. The selection unit 11 of the communication device 1 transmits to a different communication device 1 in a regular cycle via the network IF 30, a priority frame that includes a priority of the communication device 1 of the selection unit 11 and the domain number to which the communication device 1 of the selection unit 11 belongs, and that notifies the priority. In a case of communication device (1), the selection unit 11 transmits to a different communication device 1 in a regular cycle, a priority frame that includes a priority of communication device (1) and domain number (1) to which communication device (1) belongs. In a case of communication device (4), the selection unit 11 transmits to a different communication device 1 in a regular cycle, a priority frame that includes a priority of communication device (4) and domain number (2) to which communication device (4) belongs. In a case of communication device (7), the selection unit 11 transmits to a different communication device 1 in a regular cycle, a priority frame that includes a priority of communication device (7) and domain number (3) to which communication device (7) belongs.

The selection unit 11 confirms the domain number in the priority frame received from a different communication device 1. In a case where the domain number in the priority frame and the domain number set in the domain management unit 12 match, the selection unit 11 compares the priority in the priority frame with the priority of the communication device 1 of the selection unit 11. As a result of comparison, in a case where the priority of the communication device 1 of the selection unit 11 is lower than the priority in the priority frame received, the selection unit 11 stops transmission of the priority frame.

A description will be given with a specific example. In FIG. 4, assume that communication device (k) has a priority k. k is any integer from 1 to 9. Assume that the larger the k, the higher the priority. Since a priority of communication device (3) is highest in domain D (1) of FIG. 4, communication device (1) and communication device (2) stop the transmission of the priority frame.

In a case where the priority frame with which the domain numbers match and that has a higher priority than the priority of the communication device 1 of the selection unit 11 is not received even when time set has passed since receipt of the priority frame is started, the selection unit 11 of the communication device 1 determines that the communication device 1 of the selection unit 11 is the communication device 1 with the highest priority in the domain set in the domain management unit 12. In a case where the selection unit 11 of the communication device 1 determined the communication device 1 of the selection unit 11 is the communication device 1 with the highest priority, the selection unit 11 determines that the communication device 1 of the selection unit 11 is the grandmaster. The grandmaster stops the transmission of the priority frame that is transmitted in a regular cycle. From domain D (1), communication device (3) is selected as the grandmaster, from domain D (2), communication device (6) is selected as the grandmaster, and from domain D (3), communication device (9) is selected as the grandmaster.

The communication device 1 that is selected as the grandmaster in each domain also belongs to reserved domain D (0) described above. The domain management unit 12 of the communication device 1, the communication device 1 being selected as the grandmaster, sets domain D (0) as a domain setting.

<Step S12>

A network grandmaster that will appear hereinafter will be written as NW/GM. In a plurality of first representative devices selected from each domain, the domain management unit 12 of each sets a common domain to which the plurality of first representative devices belong, and the selection unit 11 of each selects a second representative device that represents the common domain from the plurality of first representative devices. The common domain is domain D (0). The second representative device is communication device (9) to be described later that is selected as the NW/GM. The domain management unit 12 of the communication device 1, the communication device 1 being selected as the grandmaster, sets the domain setting to and manages domain D (0). In step S12, a network grandmaster is selected from a plurality of grandmasters that belong to domain D (0). The selection units 11 of the communication devices 1, each of the communication devices 1 being selected as the grandmaster in each domain, select a network grandmaster that is a grandmaster of an entire network. In FIG. 4, an NW/GM is selected by the selection units 11 of communication device (3), communication device (6), and communication device (9), communication device (3), communication device (6), and communication device (9) being selected as the grandmasters. A method for selection of the NW/GM is the same as step S11. In FIG. 4, since a priority of communication device (9) is highest, in domain D (0), communication device (9) is selected as the NW/GM from communication device (3), communication device (6), and communication device (9).

<Step S13>

In the second representative device that is the NW/GM, the time transmission unit 14 transmits to the grandmaster, the first representative device, first time-synchronizing information 81 for synchronizing time. Hereinafter, a description will be given specifically. In step S13, the NW/GM transmits the first time-synchronizing information 81 that is the time information. Hereinafter, a description will be given based on FIG. 4. In communication device (9) that is selected as the NW/GM, a time delivering unit 17 transmits to communication device (3) and communication device (6) of domain D (0) via the network IF 30, the first time-synchronizing information 81 for synchronizing time. Information that identifies domain D (0) is also stored in the first time-synchronizing information 81.

<Step S14>

In step S14, the grandmaster corrects the time information using the first time-synchronizing information 81. Time management units 13 of communication device (3) and communication device (6) of domain D (0), communication device (3) and communication device (6) of domain D (0) being which received the first time-synchronizing information 81 from communication device (9), communication device (9) being the NW/GM, correct the time information that communication device (3) and communication device (6) have based on the first time-synchronizing information 81 received.

<Step S15>

In the grandmaster that is the first representative device, in a case where the first time-synchronizing information 81 is received, the time transmission unit 14 generates second time-synchronizing information 82 for synchronizing time that includes identification information that identifies the domain that the domain setting indicates, and transmits the second time-synchronizing information 82 generated. In a case where the first representative device is communication device (3), the identification information that identifies a domain that the domain setting indicates, identifies domain D (1), and in a case where the first representative device is communication device (6), the identification information that identifies a domain that the domain setting indicates is the identification information that identifies domain D (2).

Hereinafter, a description will be given specifically.

In step S15, the grandmaster transmits the second time-synchronizing information 82. In communication device (3) that is selected as the grandmaster of domain D (1), the time transmission unit 14 transmits the second time-synchronizing information 82 to the communication device 1 of domain D (1). In communication device (1) and communication device (2) that received the time information from communication device (3), communication device (3) being the grandmaster, the time management units 13 correct the time information of the time management units 13 based on the second time-synchronizing information 82 received. In communication device (6) that is selected as the grandmaster of domain D (2), the time transmission unit 14 transmits the second time-synchronizing information 82 to the communication device 1 of domain D (2). In communication device (4) and communication device (5) that received the second time-synchronizing information 82 from communication device (6), communication device (6) being the grandmaster, the time management units 13 correct the time information of the time management units 13 based on the second time-synchronizing information 82 received. As with step S14 and step S15, in the grandmaster that is the first representative device, in a case where the first time-synchronizing information 81 is received, the time management unit 13 corrects time based on the first time-synchronizing information 81. The time transmission unit 14 generates the second time-synchronizing information 82 based on the time that is corrected and transmits the second time-synchronizing information 82.

Communication device (9) that is the NW/GM transmits the first time-synchronizing information 81 to the communication device 1 of domain D (3). In communication device (7) and communication device (8) that received the first time-synchronizing information 81 from communication device (9), communication device (9) being the NW/GM, the time management units 13 correct the time information of the time management units 13 based on the first time-synchronizing information 81 received.

*** Effects of Embodiment 1 ***

In the communication system 100 of Embodiment 1, communication device (1) to communication device (9) belong to any one of domain D (1), domain D (2), and domain D (3). In each of domain D (1), domain D (2), and domain D (3), communication device (3), communication device (6), and communication device (9) are respectively selected as the grandmaster. Communication device (9) is selected as the NW/GM in domain D (0) from communication device (3), communication device (6), and communication device (9) that are selected as the grandmasters. Communication device (9) that is the NW/GM transmits the first time-synchronizing information 81 to communication device (3) and communication device (6) that are the grandmasters.

Communication device (3) and communication device (6) transmit the second time-synchronizing information 82 respectively to domain D (1) and domain D (2).

Therefore, according to the communication system 100 of Embodiment 1, even when there is a limit to the maximum number of connections to the communication device 1 and a time synchronization system is a system in which the grandmaster selected performs time transmission, time synchronization will be possible in each communication device 1 that exceeds the maximum number of connections.

In the communication system 100 of Embodiment 1, as for the method for selection of a grandmaster and an NW/GM or for time transmission, the method for selection of a grandmaster and an NW/GM or for the time transmission conforms to IEEE802.1AS.

IEEE802.1AS, however, is one example, and the communication system 100 can be applied to a time synchronization protocol that corresponds to IEEE802.1AS.

Embodiment 2.

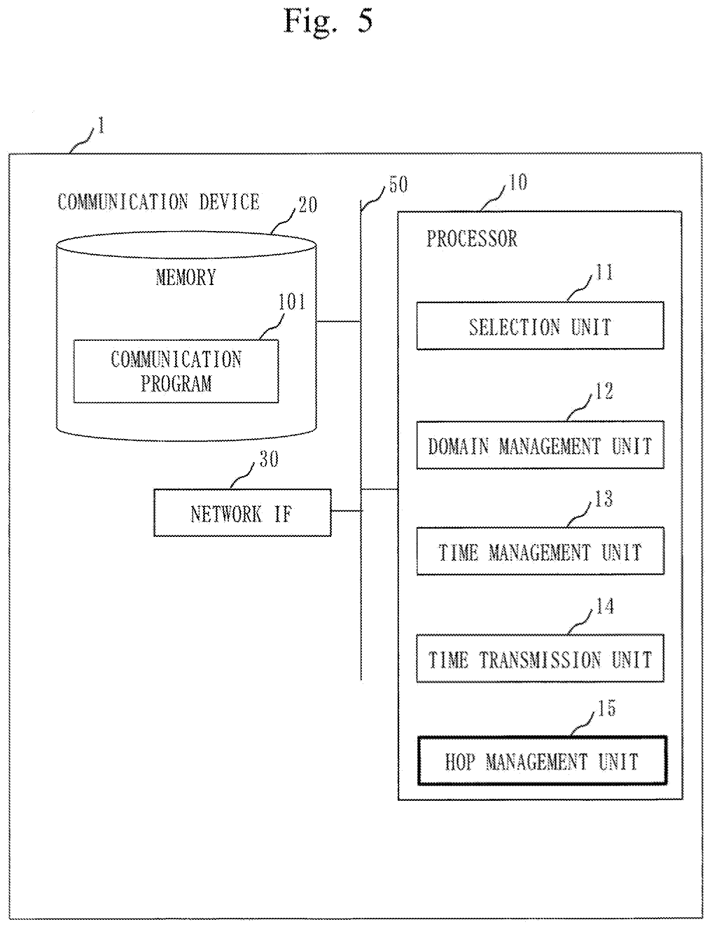

Embodiment 2 will be described by referring to FIG. 5 to FIG. 11. In Embodiment 1, an NW/GM is selected from grandmasters, each of the grandmasters being a grandmaster selected in each domain of a plurality of domains, the plurality of domains being a domain having been divided in a network.

Then, time information is transmitted from the NW/GM to the grandmaster, and then from the grandmaster to the communication device 1 in each domain. In a case of the time synchronization of Embodiment 1, the time synchronization can be realized in a network exceeding “the maximum connection stations in a same domain” specified in the protocol.

A transmission path delay, however, becomes accumulated to transmission of the time information from the grandmaster. As in FIG. 1, in a network configuration that is configured of the connection being in a line, in a case where positioning of the communication devices 1 is done in a way that the communication devices 1 of the same domain is scattered, accuracy in the time synchronization in the same domain can be reduced because of the transmission path delay being added at a time of a time delivery. In FIG. 1, communication device (1), communication device (2), and communication device (3) belong to domain D (1), communication device (4), communication device (5), and communication device (6) belong to domain D (2), communication device (7), communication device (8), and communication device (9) belong to domain D (3), and the communication devices 1 of the same domain are scattered.

In Embodiment 2, domains are reorganized.

FIG. 5 illustrates a configuration of a communication device 1 of Embodiment 2. The communication device 1 of Embodiment 2 has a hop management unit 15 added as a functional element to the communication device 1 of Embodiment 1. The hop management unit 15 manages a relay hop count.

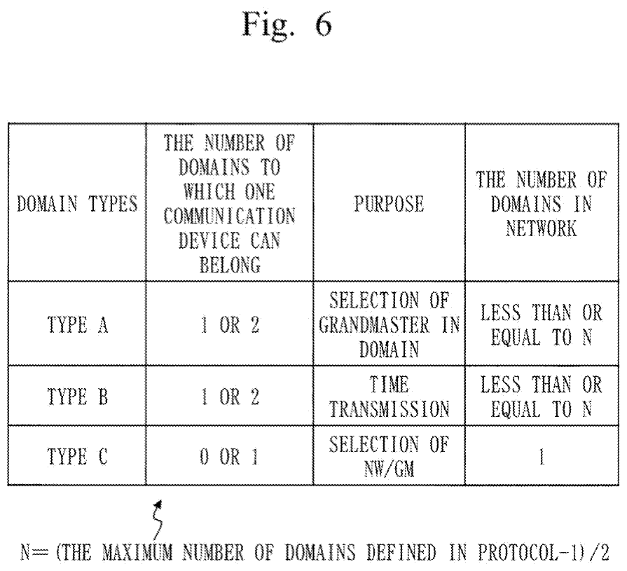

FIG. 6 illustrates domain types to be used in Embodiment 2. In Embodiment 2, domains to which the communication devices 1 belong are grouped into three types of domain types illustrated in FIG. 6. As illustrated in FIG. 6, as types that indicate the domain types, type A, type B and type C are set. For each type, “the number of domains to which one communication device can belong”, “purpose”, and “the number of domains in a network” are set. Type A is as follows. “The number of domains to which one communication device can belong” is “1 or 2”, “purpose” is “selection of a grandmaster in a domain”, and “the number of domains in a network” is less than or equal to N. N is as a following equation. N=(the maximum number of domains defined in the protocol-1)/2. Type B is as follows. “The number of domains to which one communication device can belong” is “1 or 2”, “purpose” is “time transmission”, and “the number of domains in a network” is less than or equal to N. Type C is as follows. “The number of domains to which one communication device can belong” is “0 or 1”, “purpose” is “selection of an NW/GM”, and “the number of domains in a network” is 1.

The communication device 1 that connects to the network belongs to the domain of type A and the domain of type B. At a starting point in time of the time synchronization, the communication device 1 belongs to the domain of type A, and the communication device 1 selects a grandmaster in each domain of type A. Communication devices 1 that are selected as the grandmaster in each domain of type A belong to a domain of type C, and participate in selection of an NW/GM. The domain of type B is used for a time delivery from the NW/GM to be described later.

*** Description of Operation ***

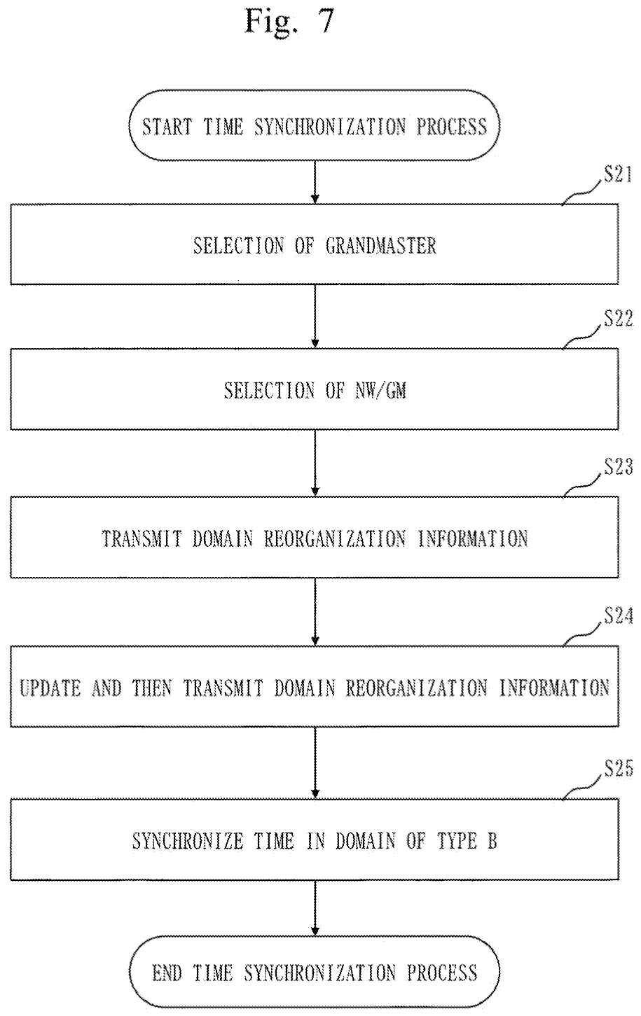

FIG. 7 is a flowchart illustrating operation of the communication system 100.

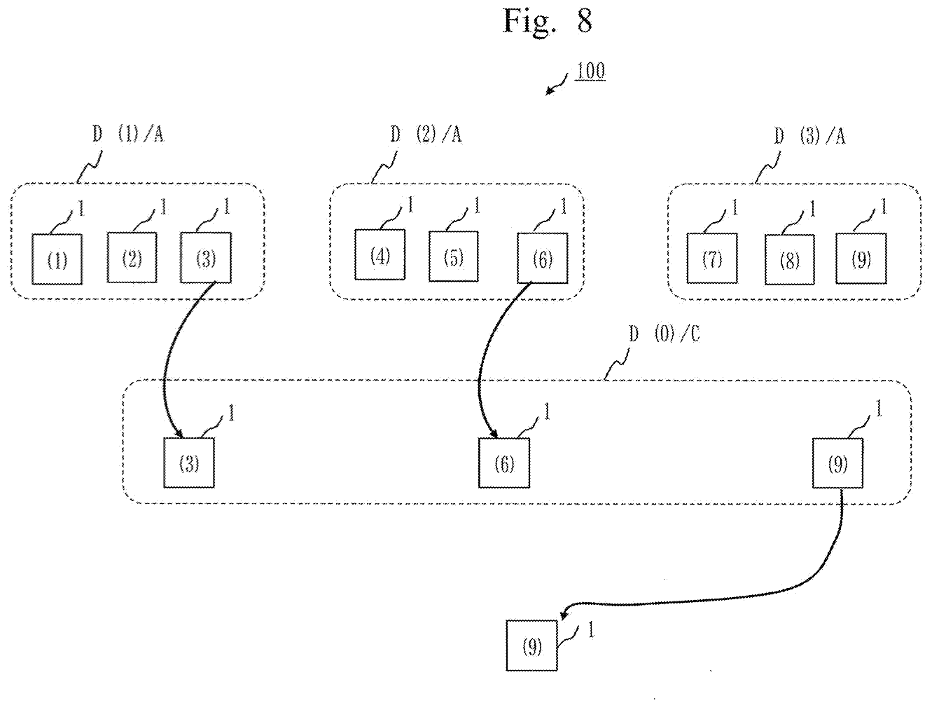

FIG. 8 schematically illustrates the operation of the communication system 100. The operation of the communication system 100 will be described by referring to FIG. 7 and FIG. 8.

<Step S21>

A grandmaster is selected in step S21. Each communication device 1 selects a grandmaster in a domain of type A. Step S21 in which selection of the grandmaster is performed is the same as step S11 of Embodiment 1. Specifically, step S21 is as follows. As illustrated in FIG. 8, each communication device 1 belongs to the domain of type A. All of domain D (1), domain D (2), and domain D (3) are type A. Communication device (1), communication device (2), and communication device (3) belong to domain D (1). Communication device (4), communication device (5), and communication device (6) belong to domain D (2).

Communication device (7), communication device (8), and communication device (9) belong to domain D (3).

As with step S11, communication device (3) is selected as the grandmaster from domain D (1), communication device (6) is selected as the grandmaster from domain D (2), and communication device (9) is selected as the grandmaster from domain D (3).

<Step S22>

In step S22, an NW/GM is selected. Hereinafter, a description will be given specifically by referring to FIG. 8. Communication device (3), communication device (6), and communication device (9) that are selected as the grandmasters in domain D (1), D (2), and D (3) of type A belong to domain D (0) of type C. Each communication device 1 that belongs to domain D (0) of type C selects the NW/GM. A method for selection of the NW/GM of step S22 is the same as step S12. Communication device (9) is selected as the NW/GM from domain D (0) of type C.

<Step S23>

In step S23, in the NW/GM that is the second representative device, the hop management unit 15 transmits relay data. In the relay data, new domain information that indicates a domain to which the communication device 1 should newly belong and type information that indicates a type of the domain that the new domain information indicates are included, the relay hop count to be relayed is set as a setting value, and the relay hop count is recorded as a relay history. In the description hereinafter, the relay data is domain reorganization information 90, the relay history of the relay hop count is a relay hop count 91, the new domain information is a domain number 92, and the type information is a domain type 93. In step S23, the domain reorganization information 90 is transmitted. Since domain D (0) to domain D (3) are already set, in communication device (9) that was selected as the NW/GM, the domain management unit 12 sets domain D (4) of domain number 4 as the domain of type B. In communication device (9) that is selected as the NW/GM, the hop management unit 15 generates the domain reorganization information 90 of domain D (4) of type B and transmits the domain reorganization information 90. The above, specifically, is as follows.

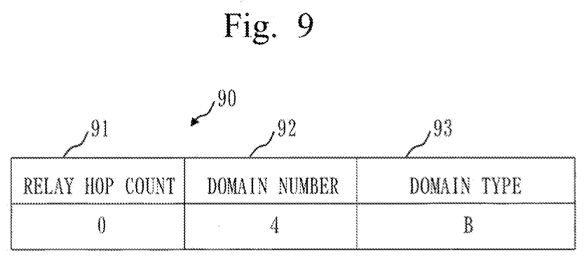

FIG. 9 illustrates the domain reorganization information 90. The domain reorganization information 90 has the relay hop count 91, the domain number 92, and the domain type 93. The domain reorganization information 90 has the relay hop count 91=0, the domain number 92=4, and the domain type 93=B. Every time the domain reorganization information 90 is relayed, the relay hop count 91 is increased by the hop management unit 15 of the communication device 1 that relays the domain reorganization information 90.

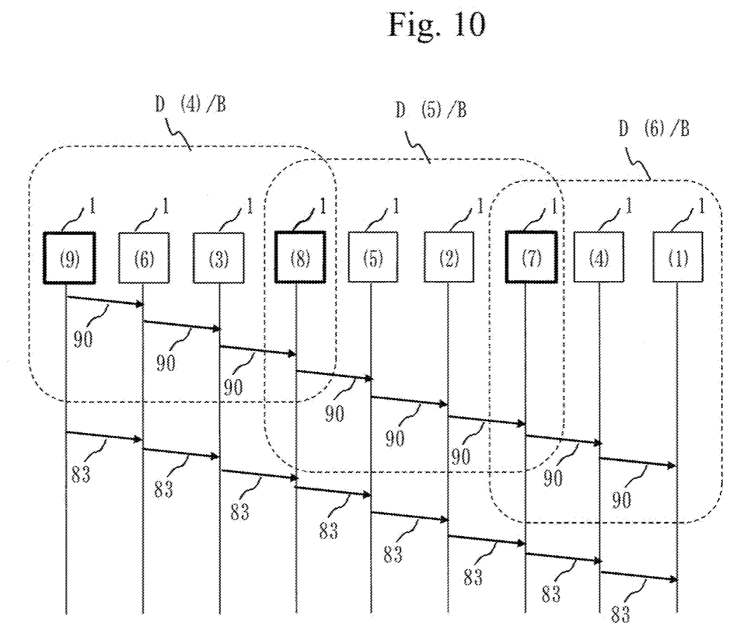

FIG. 10 illustrates reorganization of domains. A description will be given specifically by referring to FIG. 10. Assume that communication device (6) receives the domain reorganization information 90 transmitted by communication device (9) that is the NW/GM. In communication device (6) that received the domain reorganization information 90, the domain management unit 12 discovers that communication device (6) belongs to domain D (4) of type B. Then, the hop management unit 15 of communication device (6) increases the relay hop count 91 of the domain reorganization information 90 to make the relay hop count 91=1, and transmits the domain reorganization information 90.

<Step S24>

In step S24, the hop management unit 15 verifies whether or not the relay history of the relay data has reached the setting value. In a case where the relay history is less than the setting value, the hop management unit 15 transmits the relay data. In a case where the relay history has reached the setting value, the hop management unit 15 changes the new domain information of the relay data to a domain that is to be used for a first time, resets the relay history, and transmits the relay data.

Hereinafter, a description will be given specifically.

In step S24, the domain reorganization information 90 is updated, and the domain reorganization information 90 that is updated is relayed. In a case where the relay hop count 91 of the domain reorganization information 90 matched a relay hop count defined in the protocol, the hop management unit 15 stops, in the communication device 1 where the relay hop count 91 matched the relay hop count defined in the protocol, relaying of the domain reorganization information 90.

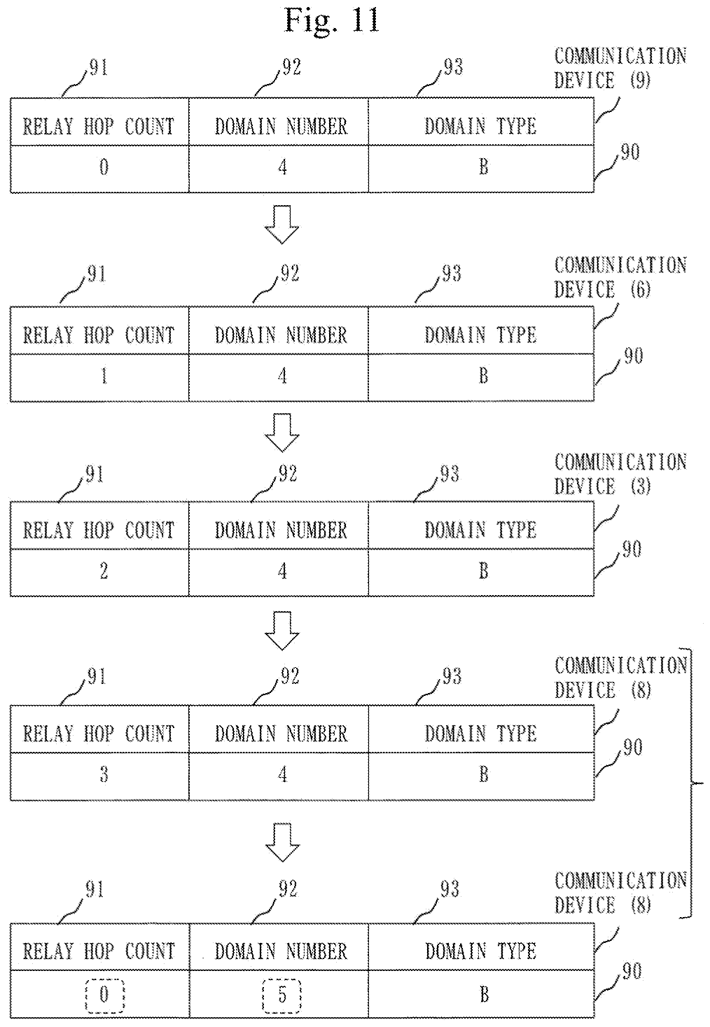

FIG. 11 illustrates changes in the domain reorganization information 90. Assume that the relay hop count defined in the protocol is 3. As illustrated in FIG. 10, assume that the domain reorganization information 90 is relayed from the NW/GM to communication device (6), then communication device (3), and then to communication device (8). As illustrated in FIG. 11, in communication device (6), the relay hop count 91 will be the relay hop count 91=1, in communication device (3), the relay hop count 91 will be the relay hop count 91=2, and in communication device (8), the relay hop count 91 will be the relay hop count 91=3. Since in communication device (8), the relay hop count 91=3 matches the relay hop count defined in the protocol, the hop management unit 15 stops relaying of the domain reorganization information 90. Communication device (1) to communication device (9) know that the relay hop count defined in the protocol is 3. The relay hop count defined in the protocol is set in the hop management unit 15.

In communication device (8), as for the domain reorganization information 90 received, the hop management unit 15 updates the domain reorganization information 90 by changing domain number 4 of domain D (4) to domain number 5, that is the domain number increased by 1, and by resetting the relay hop count to 0, and transmits domain reorganization information 90 that is updated. In other words, in the domain reorganization information 90 that communication device (8) transmits, the relay hop count 91=0, the domain number 92=5, and the domain type 93=B.

Subsequently, the process of step S24 is repeated until the domain reorganization information 90 reaches a communication device 1 on an end, and organizing of domains of type B is performed.

Specifically, step S24 is as follows. Since the relay hop count defined in the protocol is the relay hop count=3, the domain reorganization information 90 that communication device (8) transmits is relayed to communication device (5), then to communication device (2), and then to communication device (7). In communication device (5), the relay hop count 91 will be the relay hop count 91=1, in communication device (2), the relay hop count 91 will be the relay hop count 91=2, and in communication device (7), the relay hop count 91 will be the relay hop count 91=3. In communication device (7), as for the domain reorganization information 90 received, the hop management unit 15 updates the domain reorganization information 90 by increasing the domain number by 1 to change to domain 6 and by resetting the relay hop count to 0, and transmits the domain reorganization information 90. In the end, the domain reorganization information 90 that communication device (7) transmitted is relayed to communication device (4) and then to communication device (1). By the domain reorganization information 90 being relayed, communication device (k) discovers a domain to which communication device (k) belongs, and that the domain is type B.

<Step S25>

In step S25, in the NW/GM that is the second representative device, the time transmission unit 14, after transmitting the relay data, transmits time synchronization information for synchronizing time that includes type information indicating a domain type. In the description hereinafter, “time synchronization information for synchronizing time that includes type information indicating a domain type” is type and time information 83. Hereinafter, a description will be given specifically. In step S25, the NW/GM transmits the type and time information 83 that is the time information. Communication device (9) that is the NW/GM transmits the type and time information 83 having time information that has designated a domain of type B. Since the type and time information 83 is relayed in order of communication device (9), (6), (3), (8), (5), (2), (7), (4), and (1), the relay hop count can be decreased in a relay as a whole compared with a case where a domain of type A before a change is designated, transmission will be with the minimum hop count, and effects of the transmission path delay will be reduced.

*** Effects of Embodiment 2 ***

In Embodiment 2, the NW/GM reorganizes a domain by transmitting the domain reorganization information 90, and after domain reorganization, transmits the type and time information 83. Thus, in addition to the effects of Embodiment 1, since the time information can be delivered with the minimum hop count, the time synchronization can be realized more accurately than in Embodiment 1.

In the communication system 100 of Embodiment 2, as for the method for selection of a grandmaster and an NW/GM or for time transmission, the method for selection of a grandmaster and an NW/GM or for the time transmission conforms to IEEE802.1AS.

IEEE802.1AS, however, is one example, and the communication system 100 can be applied to a time synchronization protocol that corresponds to IEEE802.1AS.

In Embodiment 2, the domain for selection of the NW/GM has been of two levels, but the domain may be of multiple levels by further increasing domain types. This is the same for Embodiment 1.

### Reference Signs List

1: communication device; 10: processor; 11: selection unit; 12: domain management unit; 13: time management unit; 14: time transmission unit; 15: hop management unit; 20: memory; 30: network IF; 50: signal line; 81: first time-synchronizing information; 82: second time-synchronizing information; 83: type and time information; 90: domain reorganization information; 91: relay hop count; 92: domain number; 93: domain type; 100: communication system; 101: communication program.

1. A communication system comprising:
a plurality of communication devices, wherein
each communication device of the plurality of communication devices includes processing circuitry, wherein
the processing circuitry has a domain setting that indicates a domain among a plurality of domains to which the communication device belongs,
in a plurality of the communication devices that belong to the domain that is a same, the processing circuitry of each selects a first representative device that is a communication device that represents the domain that is the same, and
in a plurality of the first representative devices selected from each of the domains, the processing circuitry of each sets a common domain to which the plurality of the first representative devices belong, and selects a second representative device that represents the common domain from the plurality of the first representative devices.

2. The communication system according to claim 1, wherein
in the second representative device, the processing circuitry transmits first time-synchronizing information for synchronizing time to the first representative device, and
in the first representative device, in a case where the first time-synchronizing information is received, the processing circuitry generates second time-synchronizing information for synchronizing time that includes identification information that identifies the domain that the domain setting indicates, and transmits the second time-synchronizing information generated.

3. The communication system according to claim 2, wherein
the processing circuitry of the first representative device corrects time based on the first time-synchronizing information in a case where the first time-synchronizing information is received, and
generates the second time-synchronizing information based on the time that is corrected.

4. The communication system according to claim 1, wherein
in the second representative device, the processing circuitry transmits relay data in which new domain information that indicates a domain to which the communication device should newly belong and type information that indicates a type of the domain that the new domain information indicates are included, a relay hop count to be relayed is set as a setting value, and the relay hop count is recorded as a relay history,
in the communication device that received the relay data, the processing circuitry verifies whether or not the relay history of the relay data has reached the setting value, transmits the relay data in a case where the relay history is less than the setting value, and in a case where the relay history has reached the setting value, changes the new domain information of the relay data to a domain to be used for a first time, resets the relay history, and transmits the relay data, and
in the second representative device, the processing circuitry, after transmitting the relay data, transmits time synchronization information for synchronizing time that includes the type information.
